(19) United States
(12) Patent Application Publication
(10) Pub. No.: US 2008/0091488 A1
(43) Pub. Date: Apr. 17, 2008

(54) DATA DASHBOARD

(76) Inventor: Lori Ann Hughes Hempstead, Litlle Falls, NY (US)

Correspondence Address: MICHAEL RIES, 318 PARKER PLACE, OSWEGO, IL, 60543, US

(21) Appl. No.: 11/872,710

(22) Filed: Oct. 16, 2007

Related U.S. Application Data
(60) Provisional application No. 60/852,074, filed on Oct. 16, 2006.

(51) Int. Cl. G06F 17/30

(52) U.S. Cl. 705/7

(57) ABSTRACT

The present invention is a one page data dashboard of all revenue generated by a single department. The dashboard allows for trending across months and during a month. Revenue reports are generated by dozens of pages of individual bills. The dashboard succinctly organizes all revenue onto a single page that can be done manually or electronically so that the responsible party for revenue can interpret the data quickly and take any action that may be needed.

This application claims priority to U.S. Provisional Application 60/852,074 filed Oct. 10, 2006, the entire disclosure of which is incorporated by reference.

### TECHNICAL FIELD & BACKGROUND

The present invention generally relates to the field of data dashboards. More specifically, the present invention relates to organizing data in a fashion that can be summarized and managed aggressively.

The present invention is a data dashboard that may be used to show emergency department revenue in a fiscal year of revenue data set up in a monthly design. The data dashboard is a one-page document that gives the reviewer a summary of a department's revenue in a fashion that allows for action planning.

A first section of the dashboard of the present invention is for tracking volume and may be called total emergency department volume or ED VOLUME. This is done so that each patient visit equates to one bill. Most ED's do not bill for left without being seen (LWBS) so that number is included in the total. MD and Facility no charge is also a popular category so is also included. All the visits that total the volume will be captured in this section. The first priority of any party responsible for ED revenue is to ensure the accurate amount of bills are dropped. Unless the entire ED is electronic, the medical record from which the bill is derived is a manual paper system that allows for record loss. The total emergency department volume may have data fields called ED Volume, LWBS, Fac No Char, MD No Char and CR 24.

A second section of the present invention may be called Facility Charges of the dashboard that describes the facility charges and separates them by levels and may be called AGH ED FAC. There is more revenue attached to levels with procedures therefore levels with procedures are separated out (level 3+). Each patient visit is billed by level of care. This stratification allows the reviewer to evaluate the department's bell curve. Level 6 or critical care is also captured in this section. Incremental critical charges over the original are captured under critical care additional +. The next line is the total number of bills dropped and then a weighted mean is calculated. The weighted mean allows the reviewer to evaluate any subtle or substantial changes in the billing and coding. One could easily pick up a new coder that under codes. The weighted mean gives the reviewer a number to benchmark revenue. This should be carried out to 1 decimal point.

A third section may be called Professional Charges this area may be based upon the American Medical Association evaluation and management codes 99281 through 99285 and critical care. The levels without procedures attached are separated and stratified by acuity. This allows for the evaluation of the bell curve. The next line is the total number of professional bills dropped and then the weighted mean of the bell curve. The professional charge is set up like the facility charge. Depending on whether the ED MD group is fee for service or employed, if the hospital employs the group, this is tracked by the person evaluating ED revenue.

A fourth section may be called Total Gross Revenue. This section of the dashboard captures all areas of revenue that is generated by the emergency department. Revenue from the facility charges, then any supply charges, and professional charges (if the hospital bills for the physician practice). The total gross revenue is then calculated and then divided by the total billable visits or “rev/visit”. Although gross revenue can be affected by tracking, the net is affected by per diems negotiated by different payers. This dashboard is not to track net revenues.

The Diff/vol/Fac and DiffVol/Prof lines are the difference between the total emergency department volume and the number of facility bills dropped. The next line is the difference between the total emergency department volume and the number of professional bills dropped. Although there are a few days lag time before records are coded and billed, this section allows the reviewer to evaluate whether billing is behind or if too many charts are missing, not dictated or many other problems that could arise in different parts of the medical record process.

The entire page of the present invention is a 12-month summary of all revenue generated by a single ED for example. The dashboard allows for trending across months and during a month. Revenue reports are generated by dozens of pages of individual bills. The dashboard succinctly organizes all revenue onto a single page that can be done manually or electronically so that the responsible party for ED revenue can interpret the data quickly and take any action that may be needed. Although this looks very simple, the data is organized in a fashion that can be summarized and managed aggressively.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a one page chart spilt with just the top portion showing, in accordance with one embodiment of the present invention; and

FIG. 1B illustrates a one page chart spilt with just the bottom portion showing, in accordance with one embodiment of the present invention;

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

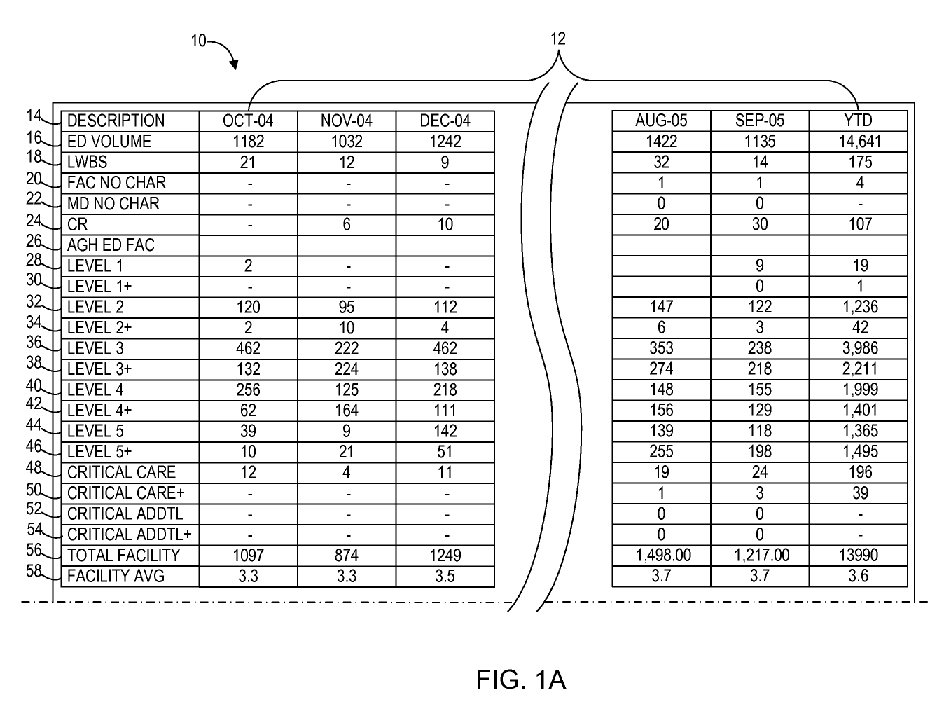

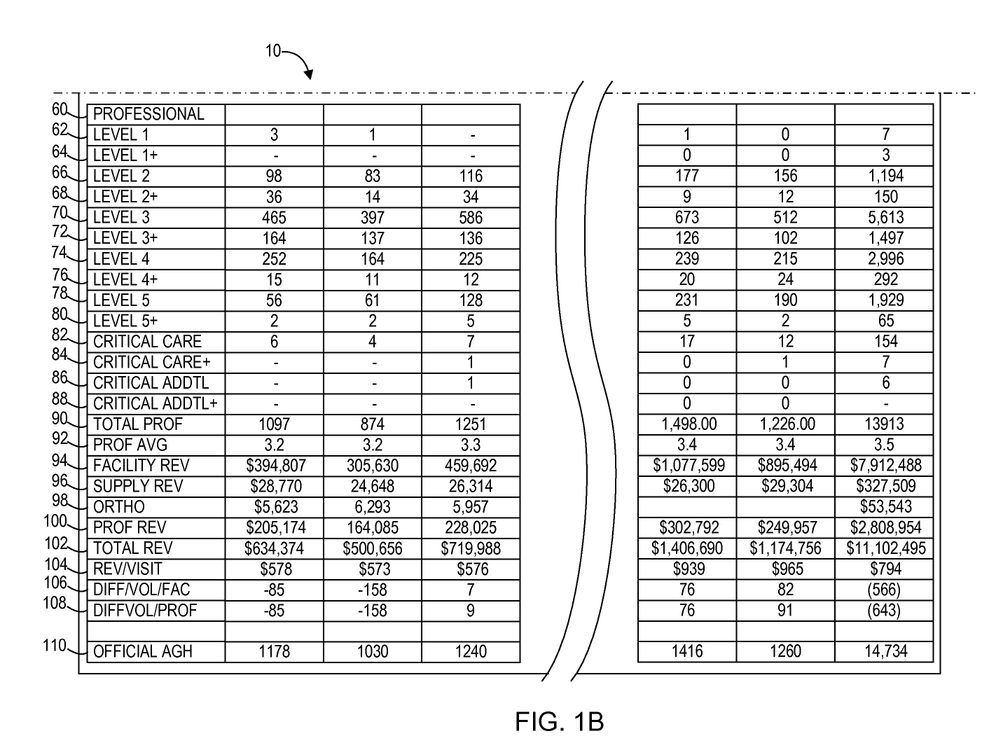

Referring now to FIG. 1, illustrated is a data dashboard 10 with a fiscal year 12 starting October 2004 and ending September 2005 with a year to date or YTD column with the entire fiscal year 12 totaled. The dashboard 10 is designed to fit on one sheet of paper for easy reading and analyzing. FIGS. 1A and 1B must be used here to conform to the patent office rules on font size. FIG. 1A is the top potion of a one page chart or dashboard 10 and FIG. 1B is the bottom portion of the one page chart. The lines between December 2004 and August 2005 columns are to show that dashboard 10 continues for the entire year and allows us to show the fonts large enough. Data will be entered into the dashboard 10 in cells that correspond to a fiscal year 12 month like October 2004 and under description 14 like ED VOLUME 16, such as the data 1182.

In FIGS. 1A and 1B under description 14 is ED Volume 16, LWBS 18, Fac No Char 20, MD No Char 22, CR 24, AGH Facility 26, Level 1 28, Level 1 (+) 30, Level 2 32, Level 2 (+) 34, Level 3 36, Level 3 (+) 38, Level 4 40, Level 4 (+) 42, Level 5 44, Level 5 (+) 46, Critical Care 48, Critical Care+ 50, Critical addtl 52, Critical addtl+ 54, Total Facility 56, Facility Avg 58, Professional 60, Level 1 62, Level 1 (+) 64, Level 2 66, Level 2 (+) 68, Level 3 70, Level 3 (+) 72, Level 4 74, Level 4 (+) 76, Level 5 78, Level 5 (+) 80, Critical Care 82, Critical Care+ 84, Critical addtl 86, Critical addtl+ 88, Total Prof 90, Prof Avg 92, Facility Rev 94, Ortho 98, Supply Rev 96, Prof Rev 100, Total Rev 102, Rev/Visit 104, Diff/vol/Fac 106, DiffVol/Prof 108 and official AGH 110.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1 A method comprising:
generating revenue reports from individual bills; and
displaying revenue data from the revenue reports into a easy to read and interpret one page summary of data chart, the one page summary shows data trends visually so a user take quick action when needed.

2. The method of claim 1 wherein the arranged data is a 12 month summary of all revenue generated by a single emergency department.

3. The method of claim 1 wherein the displayed one page summary is a dashboard that allows for trending across months and during a month.

4. The method of claim 1 wherein the dashboard succinctly organizes all revenue onto a single page that can be done a selected one of manually and electronically so that the responsible party for ED revenue can interpret the data quickly.

5. A method comprising:
generating revenue reports from individual bills;
organizing revenue data from the revenue reports into a easy to read and interpret one page summary of data chart, the data is from an entire department, the one page summary shows data trends visually so a user take quick action when needed.
